(19) United States
(12) Patent Application Publication
(10) Pub. No.: US 2008/0174680 A1
(43) Pub. Date: Jul. 24, 2008

(54) Imaging Device

(75) Inventor: Atsushi OGINO, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/939,079

(22) Filed: Nov. 13, 2007

(30) Foreign Application Priority Data
Nov. 13, 2006 (JP) 2006-306941

(51) Int. Cl. H04N 5/76

(52) U.S. Cl. 348/231.99

(57) ABSTRACT

An imaging device has an image compositing unit. The image compositing unit comprises: an edge extracting portion that extracts edges within an area containing a subject image in a captured image to generate edge information; an outline generating portion that generates an outline based on the edge information; an outline cutting portion that forms a partial image by cutting out an area in a captured image along the outline; and an image compositing portion that generates an image by combining a foreground image and a background image. The foreground image is a partial image formed by cutting out an area containing a subject image in a captured image either captured by an image sensor or selected from among captured images stored in memory. The background image is a captured image either captured by the image sensor or selected from among captured images stored in the memory.

### BACKGROUND OF THE INVENTION

1. Field of the Invention

The present invention relates to an imaging device, and more particularly relates to the process of cutting out and combining captured images.

2. Description of the Related Art

In recent years, imaging devices such as digital cameras have become popular. Users often cut out and combine images taken with such an imaging device. FIG. 16 shows a conventional imaging device 100. This imaging device 100 comprises a lens 102, an image sensor 103, an analog front end 104, an image signal processor 105, an image compositing unit 106, a display 107, a memory 108, an outline cutting unit 109, and a touch panel 110.

The imaging device 100 generates captured image data in the following manner. The image sensor 103 composed of e.g. CCD or CMOS sensors converts optical information entering through the lens 102 into electric signals representing the captured image. The analog front end 104 performs operations such as gain control and analog-to-digital conversion on the captured image signals, and sends the signals to the image signal processor 105. The image signal processor 105 performs various kinds of signal processing operations to generate the captured image data. The generated data is then displayed on the display 107 and stored in the memory 108. Further, the imaging device 100 can cut out and combine captured images by the image compositing unit 106.

When cutting out a given area in a captured image to form a partial image, the imaging device 100 cuts the outline of an area to be cut out of a captured image that is designated by a user through the use of the touch panel 110. The formed partial image is combined, by the image compositing unit 106, with a captured image stored in the memory 108 for generation of a composite image. However, since the imaging device 100 requires a user to operate the touch panel 110 for designation of an area to be cut out of a captured image, the formation of a partial image may require time and effort.

As another technique for cutting out and combining captured images, an imaging device 120 can be connected to a personal computer 130 as shown in FIG. 17. In this technique, data representing two images captured by the imaging device 120 is transferred to the personal computer 130. Then, a user operates an image editing software installed on the personal computer 130 to cut out and combine the captured images. However, this technique for cutting out and combining captured images may also require time and effort because a user has to transfer captured images to a personal computer and thereafter operate the personal computer.

### SUMMARY OF THE INVENTION

An object of the present invention is to provide an imaging device that can reduce the time and effort required for cutting out and combining images captured by the device.

According to an aspect of the present invention, this object is achieved by an imaging device comprising: imaging means for capturing an image of a subject to obtain a captured image; storage means for storing a captured image; partial image forming means for extracting an edge within an area containing a subject image in either a captured image captured by the imaging means or a captured image selected from among captured images stored in the storage means and for cutting out an outline based on the extracted edge so as to form a partial image; and image compositing means for generating an image by combining a foreground image and a background image, wherein the foreground image is a partial image formed, by the partial image forming means, by cutting out an area containing a subject image in either a captured image captured by the imaging means or a captured image selected from among captured images stored in the storage means, and the background image is either a captured image captured by the imaging means or a captured image selected from among captured images stored in the storage means.

The imaging device can automatically extract edges within an area containing a subject image in a captured image and form a partial image by cutting out an area in the captured image along an outline based on the extracted edges. Therefore, unlike conventional devices, the imaging device allows a user to cut out part of a captured image without designating an area containing the subject image in the captured image by using a touch pen or other device. Accordingly, the time and effort required for formation of a partial image can be reduced.

Further, the imaging device can generate a composite image in which the foreground image is a partial image formed, by the partial image forming means, by cutting out an area containing a subject image in either a captured image captured by the imaging means or a captured image selected from among captured images stored in the storage means, and the background image is either a captured image captured by the imaging means or a captured image selected from among captured images stored in the storage means. This allows a user to combine captured images only with the imaging device, i.e., without the need to use a personal computer or other device. Accordingly, the time and effort required for combining captured images can be reduced.

Preferably, the partial image forming means includes: edge extracting means for extracting an edge within an area containing a subject image in a captured image to generate edge information; outline generating means for generating an outline based on the edge information generated by the edge extracting means; and outline cutting means for forming a partial image by cutting out an area in a captured image along the outline generated by the outline generating means.

The image compositing means may have first compositing means for generating an image by combining a foreground image and a background image, the foreground image being a partial image formed, by the partial image forming means, by cutting out an area containing only a subject image in a captured image captured by the imaging means, the background image being a captured image selected from among captured images stored in the storage means.

The image compositing means may further have second compositing means for generating an image by combining a foreground image and a background image, the foreground image being a partial image formed, by the partial image forming means, by cutting out an area containing a subject image in a captured image selected from among captured images stored in the storage means, the background image being a captured image captured by the imaging means.

The image compositing means may further have third compositing means for generating an image by combining a foreground image and a background image, the foreground image being a partial image formed, by the partial image forming means, by cutting out an area containing a subject image in a captured image selected from among captured images stored in the storage means, the background image being a captured image selected from among captured images stored in the storage means.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a block diagram schematically showing the configuration of an imaging device according to one embodiment of the present invention;

FIG. 2 is a block diagram showing the internal configuration of an image compositing unit in the imaging device;

FIG. 3 is a flowchart showing the steps of a process for image compositing in the imaging device;

FIG. 4 is a flowchart showing the steps of a process for cutting out an image in the image compositing process;

FIG. 5 shows a captured image according to the imaging device;

FIG. 6 shows a captured image according to the imaging device;

FIG. 7 shows a partial image with edges extracted according to the imaging device;

FIG. 8 shows the captured image in which an outline is selected according to the imaging device;

FIG. 9 shows an outline cut out of the captured image according to the imaging device;

FIG. 10 shows a foreground image according to the imaging device;

FIG. 11 shows a composite image according to the imaging device;

FIG. 12 is a flowchart showing the steps of a process for image compositing in the imaging device;

FIG. 13 is a flowchart showing the steps of a process for image compositing in the imaging device;

FIG. 14 is a flowchart showing the steps of a process for display and storage of a cut out image in the imaging device;

FIG. 15 is a flowchart showing the steps of a process for image compositing in the imaging device;

FIG. 16 is a block diagram schematically showing the configuration of a conventional imaging device; and

FIG. 17 is a diagram illustrating the conventional imaging device connected to an external device.

### DESCRIPTION OF THE PREFERRED EMBODIMENTS

Referring now to the accompanying drawings, one embodiment of the present invention is described. It is to be noted that the following description of preferred embodiment of the present invention has been presented for purposes of illustration and description, and is not intended to be exhaustive or to limit the present invention to the precise form disclosed.

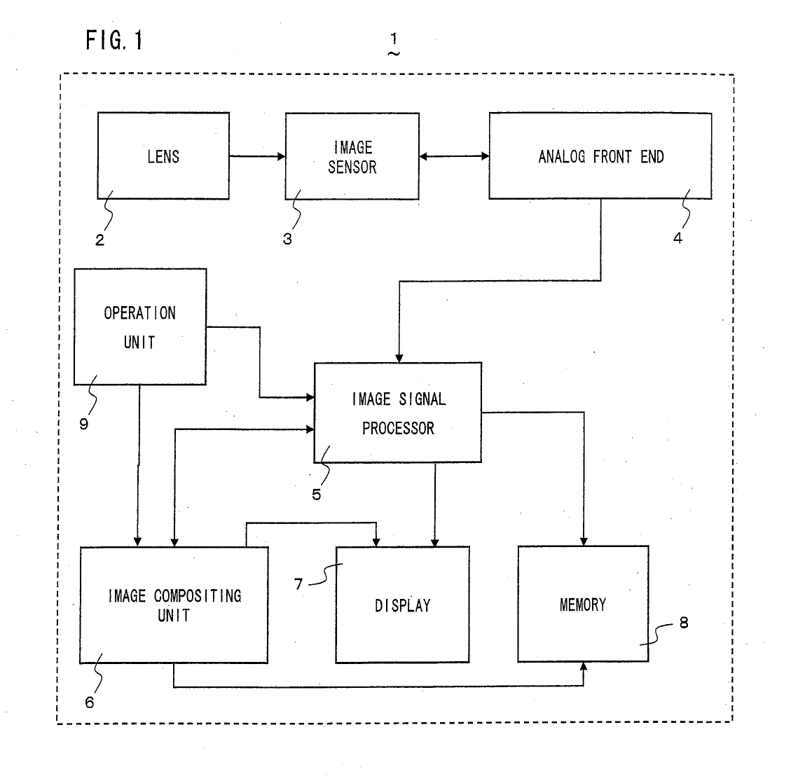

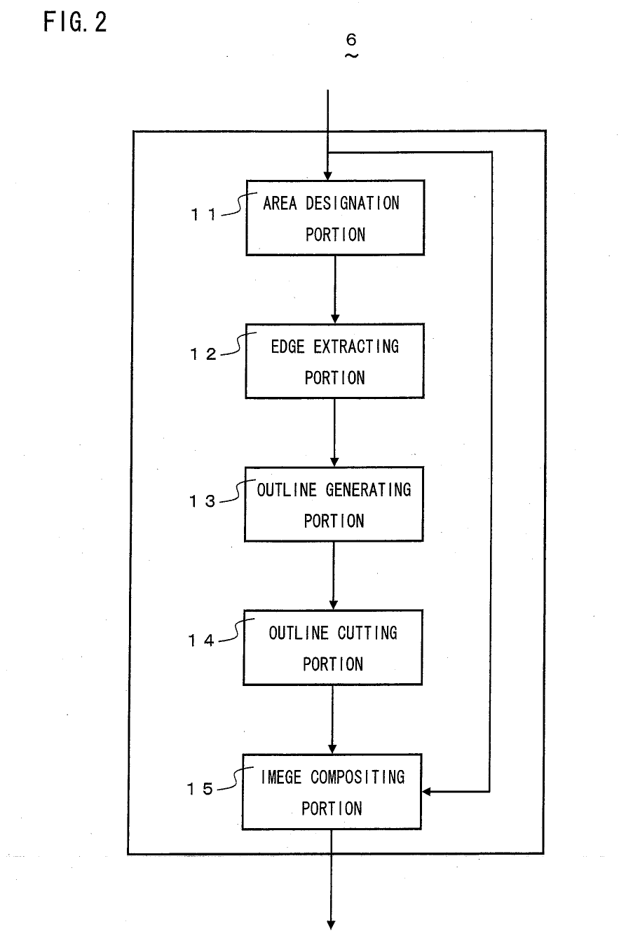

FIG. 1 shows the configuration of an imaging device 1 according to this embodiment. FIG. 2 shows the configuration of an image compositing unit 6 in the imaging device 1.

The imaging device 1 comprises: an image sensor (imaging means) 3 including a charge coupled device (CCD) that converts an object image projected through a lens 2 to electric signals; an analog front end 4, an image signal processor 5; the image compositing unit 6; a display 7; a memory (storage means) 8; and an operation unit 9. The imaging device 1 has various modes including a shooting mode only for taking images and an image composition mode for cutting out and combining images captured by the device. Each component in the device operates in accordance with the modes.

The analog front end 4 controls the image sensor 3 to perform gain control and other processing on analog image signals output from the image sensor 3 and convert the analog image signals to digital signals. The analog front end 4 then sends the digital image signals to the image signal processor 5. The image signal processor 5 performs various kinds of signal processing functions, e.g., luminance and color difference signal processing, contour correction, and white balance, on the digital image signals sent from the analog front end 4. The memory 8 stores captured image data sent from the image signal processor 5. The operation unit 9 has buttons (not shown). The operation unit 9 is operated by a user to select a mode such as the shooting mode or the image composition mode, or to trigger the image signal processor 5 and the image compositing unit 6 to perform various processings in the imaging device 1.

The display 7 displays captured images and various messages. The image compositing unit 6 can receive digital image signals from the image signal processor 5, read out a captured image stored in the memory 8, store a generated image in the memory 8, and display a generated image on the display 7. Further, the image compositing unit 6 can generate a composite image by combining two captured images, form a partial image by cutting out part of a captured image, store a composite image and a partial image in the memory 8, and display such an image on the display 7.

As shown in FIG. 2, the image compositing unit 6 has an area designation portion 11, an edge extracting portion (edge extracting means) 12, an outline generating portion (outline generating means) 13, an outline cutting portion (outline cutting means) 14, and an image compositing portion (image compositing means) 15. The above mentioned area designation portion 11, the edge extracting portion 12, the outline generating portion 13, and the outline cutting portion 14 correspond to partial image forming means recited in the claims.

The area designation portion 11 enables a user to designate an area for edge extraction in a captured image. The edge extracting portion 12 extracts edges within an area in a captured image that is designated via the area designation portion 11 or extracts edges in the entire captured image, and generates edge information. As compared to the extraction of edges in the entire image, the extraction of edges within an area in the image designated via the area designation portion 11 tends to provide precise edge information for generating an outline along which a user desires to cut out an image. In other words, the edge extraction within a designated area is more efficient. The designation of an area in an image can be performed by a user through the use of the operation unit 9. The area designation portion 11 and the edge extracting portion 12 can also perform the above described process on a captured image stored in the memory 8.

The outline generating portion 13 generates an outline based on the edge information generated by the edge extracting portion 12. The outline cutting portion 14 cuts out an area based on the outline (area along the outline) generated by the outline generating portion 13 to thereby form a partial image. When a captured image has the image of an object other than the subject, the outline generating portion 13 generates a plurality of outlines. In such a case, the outline cutting portion 14 forms a partial image by cutting out an image with the outline selected by a user through the use of the operation unit 9. The image compositing portion 15 generates an image by combining two captured images. Note that when it is not needed to form a partial image by cutting out a captured image, captured image data is sent only to the image compositing portion 15.

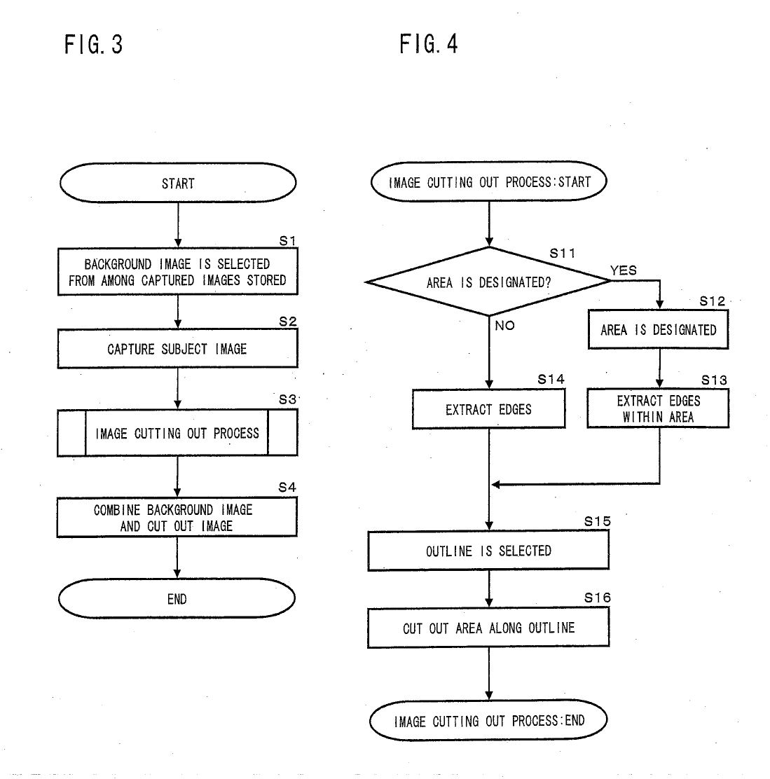

Referring now to FIG. 3, it is described how to combine a partial image cut out of a captured image captured by the image sensor 3 with a captured image stored in the memory 8. Here, assume that the imaging device 1 is already set in the image composition mode. A user selects, using the operation unit 9, a captured image to be a background image from among captured images stored in the memory 8 (S1), and takes a photo of a subject (S2). Then, the imaging device 1 generates a partial image by cutting out part of the newly captured image (S3), and generates a composite image by combining the partial image as a foreground image with the background image selected at the above step S1 (S4). The image cutting out process at the above step S3 is described below in detail.

Referring now to FIG. 4, the details of the image cutting out process at the above step S3 is described. When an area in the captured image is designated for cutting out (YES at S11), the user designates the area by operating the operation unit 9 (S12). Then, edge extraction is performed for the designated area in the captured image (S13). On the other hand, when no area is designated (NO at S11), the process at the above steps S12 and S13 is not performed but edge extraction is performed for the entire captured image (S14). Subsequently, the user can select an outline for cutting out from among outlines generated based on the extracted edge information (S15). When an outline is selected, an area based on the selected outline (area along the selected outline) is cut out so that a partial image is formed (S16). In this step, the user can select, using the operation unit 9, whether the area inside or outside the selected outline should be cut out. It is to be noted that the image cutting out process can be similarly performed for a captured image stored in the memory 8.

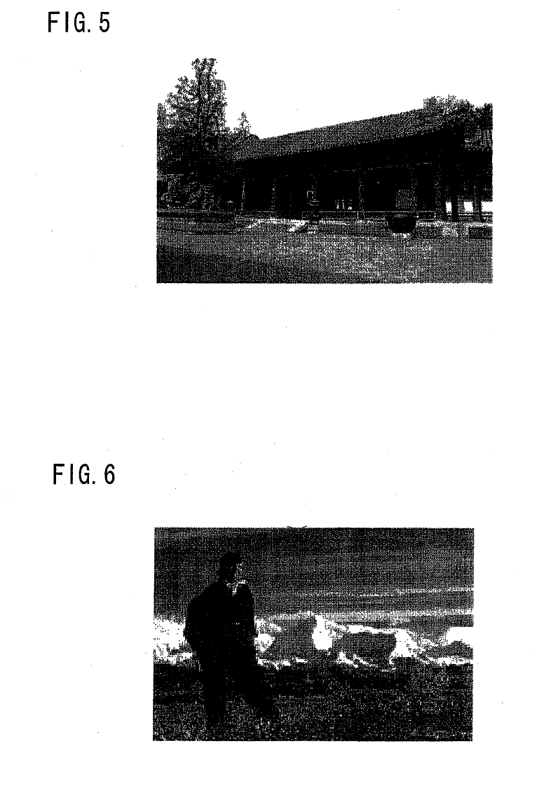

Referring now to FIG. 5 to FIG. 11, captured images at the image processing steps shown in FIG. 3 and FIG. 4 are described. FIG. 5 to FIG. 11 show each captured image after each processing step. FIG. 5 shows a captured image selected at the above step S1. FIG. 6 shows a captured image captured at the step S2.

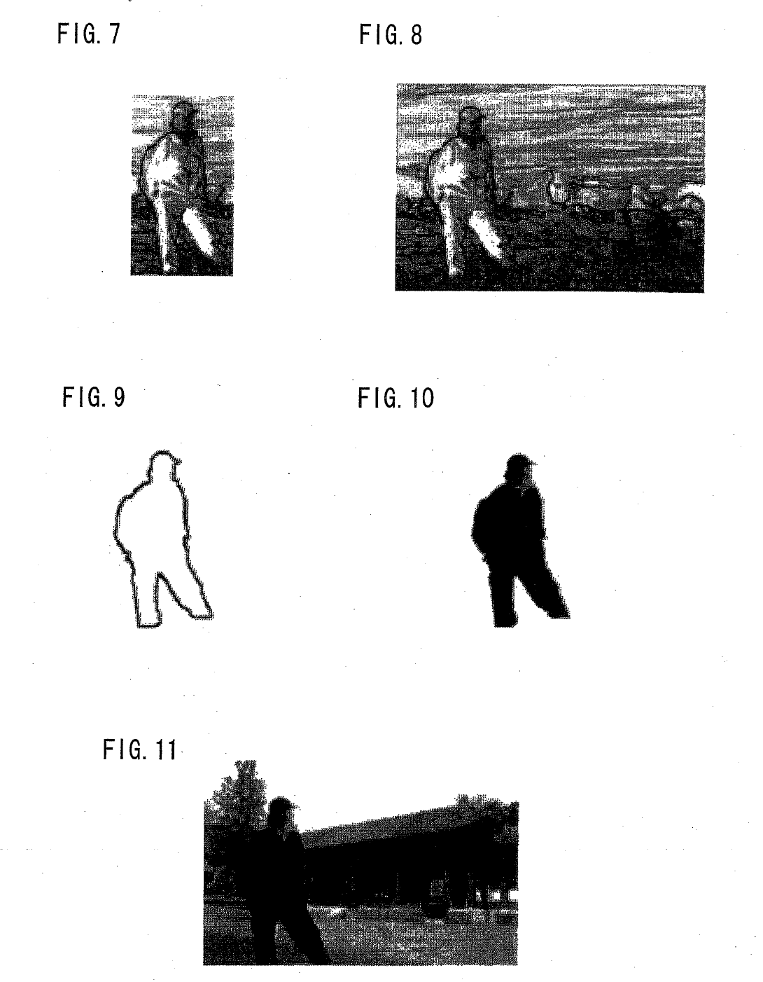

When a rectangular area enclosing a subject image in a captured image is designated in the above described image cutting out process at the step S3, image edges shown in FIG. 7 are extracted at the above step S13. On the other hand, when no area is designated, image edges shown in FIG. 8 are extracted at the above step S14. When an outline in an image area containing only the subject image is selected from the extracted edges at the above step S15, the selected outline is as shown in FIG. 9. FIG. 10 shows a partial image formed by cutting out an area in the image along the selected outline at the above step S16. FIG. 11 shows an image generated by combining the image shown in FIG. 10 as a foreground image and the image shown in FIG. 5 as a background image.

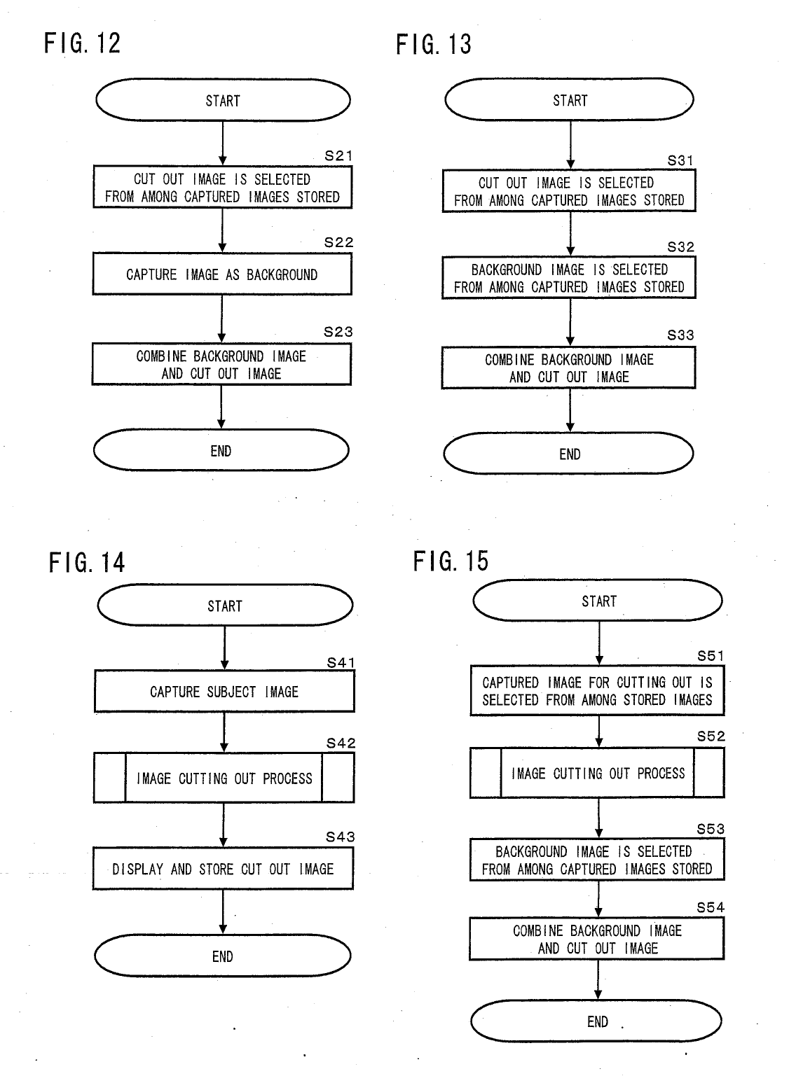

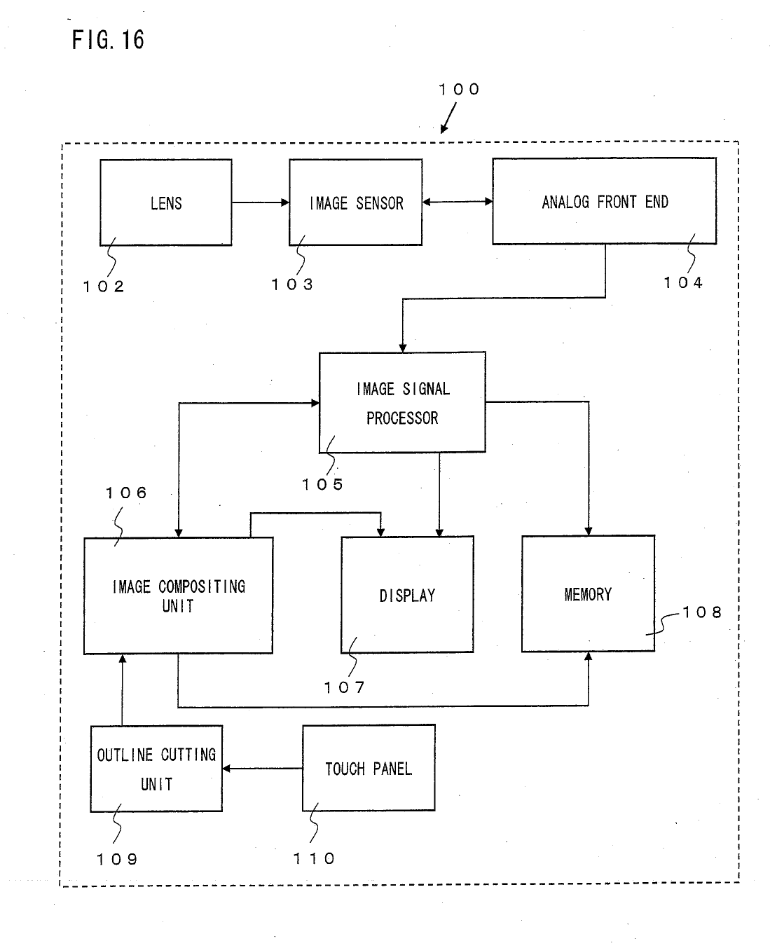

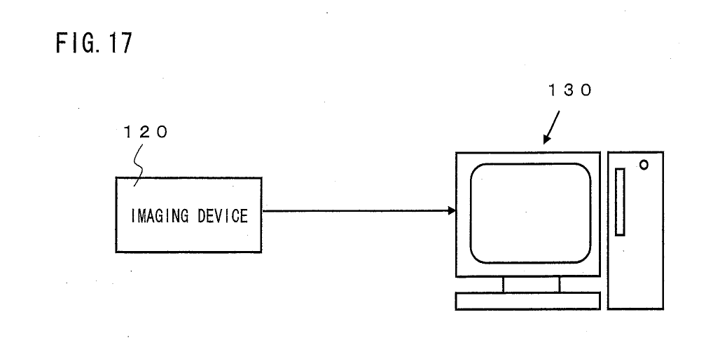

Referring now to FIG. 12, it is described the process of combining a partial image stored in the memory 8 and an image captured by the image sensor 3. Assume that the imaging device 1 is already set in the image composition mode. A user selects, using the operation unit 9, a partial image having been formed by cutting out an image area containing only a subject image from among captured images stored in the memory 8 (S21), and takes a photo (S22). Then, the imaging device 1 generates a composite image by combining the partial image selected at the step S21 as the foreground with the image captured at the step S22 as the background (S23). Where the captured image selected at the above step S21 is the image shown in FIG. 10 and the captured image captured at the above step S22 is the image shown in FIG. 5, the image generated at the above step S23 is the image shown in FIG. 11.

Referring now to FIG. 13, it is described the process of combining a partial image stored in the memory 8 and a captured image stored in the memory 8. Assume that the imaging device 1 is already set in the image composition mode. A user selects, using the operation unit 9, a partial image having been formed by cutting out an image area containing only a subject image from among captured images stored in the memory 8 (S31), and further selects a captured image to be a background image from among the captured images stored in the memory 8 (S32). Then, the imaging device 1 generates a composite image by combining the partial image selected at the above step S31 as the foreground with the captured image selected at the above step S32 as the background (S33). Where the image selected at the step S31 is the image shown in FIG. 10 and the image selected at the step S32 is the image shown in FIG. 5, the image generated at the above step S33 is that shown in FIG. 11.

Referring now to FIG. 14, it is described how to display and store a partial image cut out. Assume that the imaging device 1 is already set in the image composition mode. After the image of a subject is captured (S41), the image cutting out process is performed on the captured image to generate a partial image (S42). The generated partial image is then displayed on the display 7 and stored in the memory 8 (S43). The process of cutting out the image at the step S42 is similar to that shown in FIG. 4 and not described here. In the case where the image captured at the step S41 is that shown in FIG. 6, the partial image formed at the step S42 is the image shown in FIG. 10, which is displayed on the display 7 and stored in the memory 8.

Referring now to FIG. 15, it is described the process of combining a partial image formed by cutting out part of a captured image stored in the memory 8 with a captured image stored in the memory 8. Assume that the imaging device 1 is already set in the image composition mode. First, a user selects a captured image for cutting out from among captured images stored in the memory 8 (S51). Then, the imaging device 1 performs the image cutting out process on the selected image to generate a partial image (S52). Subsequently, the user selects, using the operation unit 9, an image to be a background image from among the captured images stored in the memory 8 (S53). In response, the imaging device 1 generates a composite image by combining the partial image at the step S52 as a foreground image with the background image selected at the step S53 (S54). The image cutting out process at the step S52 is similar to the process shown in FIG. 4 and not described here in detail. In the case where the captured image selected at the step S51 is the image shown in FIG. 6, the partial image formed at the step S52 is the image shown in FIG 10, and the captured image selected at the step S53 is the image shown in FIG. 5, the image generated at the step S54 is that shown in FIG. 11.

As described above, the imaging device 1 according to this embodiment can automatically extract edges within an area containing a subject image in a captured image and form a partial image by cutting out an outline based on the extracted edges. Therefore, unlike conventional devices, the imaging device 1 can cut out a captured image without requiring a user to designate an area containing a subject image in the captured image by using a touch pen or other device. Accordingly, the time and effort required for formation of a partial image can be reduced.

The imaging device 1 can generate a composite image in which the foreground is a partial image formed by cutting out an area containing only a subject image in a newly captured image and the background is a captured image stored in the memory. Likewise, the imaging device 1 can generate a composite image in which the foreground is a partial image that has been formed by cutting out an image area containing only a subject image and is stored in the memory 8 and the background is a newly captured image. Further, the imaging device 1 can generate a composite image in which the foreground is a partial image that has been formed by cutting out an image area containing only a subject image and is stored in the memory 8 and the background is a captured image stored in the memory 8. The imaging device I can form a partial image by cutting out an area containing only a subject image in a captured image and store the partial image as a foreground image in the memory 8.

The imaging device 1 can also generate a composite image in which the foreground is a partial image formed by cutting out an area containing only a subject image in a captured image stored in the memory 8 and the background is a captured image stored in the memory 8. This allows a user to combine captured images only with the imaging device 1, i.e., without the need to use a personal computer or other device. Accordingly, a user can easily combine already captured images.

The present invention has been described above using a presently preferred embodiment, but those skilled in the art will appreciate that various modifications are possible. For example, in the above described embodiment, the present invention is applied to the imaging device that stores captured still image data, but the present invention can be applied to other kinds of devices.

This application is based on Japanese patent application 2006-306941 filed Nov. 13, 2006, the contents of which are hereby incorporated by reference.

What is claimed is:

1. An imaging device comprising:
imaging means for capturing an image of a subject to obtain a captured image;
storage means for storing a captured image;
partial image forming means for extracting an edge within an area containing a subject image in either a captured image captured by the imaging means or a captured image selected from among captured images stored in the storage means and for cutting out an outline based on the extracted edge so as to form a partial image; and
image compositing means for generating an image by combining a foreground image and a background image, wherein the foreground image is a partial image formed, by the partial image forming means, by cutting out an area containing a subject image in either a captured image captured by the imaging means or a captured image selected from among captured images stored in the storage means, and the background image is either a captured image captured by the imaging means or a captured image selected from among captured images stored in the storage means.

2. The imaging device according to claim 1, wherein the partial image forming means includes:
edge extracting means for extracting an edge within an area containing a subject image in a captured image to generate edge information;
outline generating means for generating an outline based on the edge information generated by the edge extracting means; and
outline cutting means for forming a partial image by cutting out an area in a captured image along the outline generated by the outline generating means.

3. The imaging device according to claim 2,
wherein the image compositing means has first compositing means for generating an image by combining a foreground image and a background image, the foreground image being a partial image formed, by the partial image forming means, by cutting out an area containing only a subject image in a captured image captured by the imaging means, the background image being a captured image selected from among captured images stored in the storage means.

4. The imaging device according to claim 3,
wherein the image compositing means further has second compositing means for generating an image by combining a foreground image and a background image, the foreground image being a partial image formed, by the partial image forming means, by cutting out an area containing a subject image in a captured image selected from among captured images stored in the storage means, the background image being a captured image captured by the imaging means.

5. The imaging device according to claim 4,
wherein the image compositing means further has third compositing means for generating an image by combining a foreground image and a background image, the foreground image being a partial image formed, by the partial image forming means, by cutting out an area containing a subject image in a captured image selected from among captured images stored in the storage means, the background image being a captured image selected from among captured images stored in the storage means.
